(19) United States
(12) Patent Application Publication
(10) Pub. No.: US 2017/0108948 A1
(43) Pub. Date: Apr. 20, 2017

(54) RETRACTABLE CAPACITANCE PEN

(71) Applicant: WALTOP INTERNATIONAL CORPORATION, Hsinchu City (TW)

(72) Inventors: YING-HWA TANG, Hsinchu City (TW); HSIN-CHIANG HO, Hsinchu City (TW)

(21) Appl. No.: 14/978,389

(22) Filed: Dec. 22, 2015

(30) Foreign Application Priority Data
Oct. 16, 2015 (TW) 104216641

(51) Int. Cl. G06F 3/038; G06F 3/041; G06F 3/0354

(52) U.S. Cl. CPC G06F 3/0383; G06F 3/03545; G06F 3/041

(57) ABSTRACT

The invention relates to a retractable capacitance pen. The retractable capacitance pen comprises a pen case, an electrical signal transmitting module, an extension-and-retraction unit, and a switching unit. The extension-and-retraction unit can control the core of the electrical signal transmitting module to extend outside the pen case thereby the switching unit is activated to turn on the electrical signal transmitting module for continuously emitting electrical signals. Furthermore, the extension-and-retraction unit also can control the core of the electrical signal transmitting module to retract into the pen case thereby the switching unit is activated again to turn off the electrical signal transmitting module for stopping emitting electrical signals.

### CROSS REFERENCE

This application claims priority from Taiwan Patent Application No. 104216641, filed Oct. 16, 2015, the content of which are hereby incorporated by reference in their entirety for all purposes.

### BACKGROUND OF THE INVENTION

1. Field of the Invention

The present invention relates to a retractable capacitance pen, and particularly relates to a retractable capacitance pen which allows the circuit to be naturally switched on or switched off at the most appropriate time.

2. Description of the Prior Art

Along with popularization of touch devices (such as touch panel, touch screen phone, tablet PC, etc.), capacitance pens have been wildly used instead of users' fingers to handwriting input (means input information by handwriting) to touch devices. If the user forgets to switch on the capacitance pen, the touch device can not receive any information and data when the user uses the capacitance pen to handwriting input (means input information by handwriting) to the touch device or write on the touch device. For avoiding forgetting to switch on the capacitance pen, some capacitance pens are designed to be always maintained in switch-on situation. It means that the capacitance pen is always switched on no matter the capacitance pen is used or is not used. It results in waste of the power of the battery in the capacitance pen. Therefore, for allowing the capacitance pen to be used for a long time, the battery having smaller size (such as a mercury battery) can not be employed in the capacitance pen. The size and the weight of the capacitance pen can be decreased because of the need of the battery having bigger size. Therefore, it has a need of a capacitance pen, which is not maintained in switch-on situation all the time, and can employ the battery having smaller size (such as a mercury battery), and can be naturally switched on or switched off at the most appropriate time.

### SUMMARY OF THE INVENTION

In view of the foregoing, one object of the present invention is to provide a retractable capacitance pen. When the core of the retractable capacitance pen retracts into the retractable capacitance pen, the circuit of the retractable capacitance pen is naturally switched off (or turned off) so as to stop emitting the electrical signal. When the core of the retractable capacitance pen stretches out (or extends outside) the retractable capacitance pen, the circuit of the retractable capacitance pen is naturally switched on (or turned on) so as to continuously emit electrical signals. Therefore, the user does not worry whether the retractable capacitance pen is switched on (or turned on). It results in greatly decreasing of (electrical) power consumption of the (retractable) capacitance pen. Therefore, the battery having smaller size (such as a mercury battery) can be employed in the (retractable) capacitance pen, and the size and the weight of the (retractable) capacitance pen can be decreased. By this way, the (retractable) capacitance pen can have more variations of designs of modeling and shapes.

According to one of the objects above, a retractable capacitance pen is disclosed herein. The retractable capacitance pen comprises a pen case, an electrical signal transmitting module, an extension-and-retraction unit, and a switching unit. The electrical signal transmitting module, the extension-and-retraction unit, and the switching unit are deposited in the pen case. The electrical signal transmitting module comprises a pen frame, a core, a core holder, a spring, a sensor holder, a circuit board, and a power unit. The electrical signal transmitting module emits the electrical signal when the electrical signal transmitting module works. The extension-and-retraction unit is deposited in the pen case for bringing the electrical signal transmitting module to move vertically so as to control a front end of the core to extend outside (or stretch out) the pen case or to move back into (or retract into) the pen case. The switching unit is deposited in the pen case to be used as a switch of the electrical signal transmitting module. When the electrical signal transmitting module moves, the switching unit is triggered to control the electrical signal transmitting module to be maintained in the one of switching-on situation and switching-off situation.

Therefore, the present invention provides a retractable capacitance pen which is not maintained in switch-on situation all the time and can employ the battery having smaller size (such as a mercury battery).

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a stereo drawing illustrating a retractable capacitance pen in accordance with one embodiment of the present invention.

FIG. 2 is an explosion drawing illustrating a retractable capacitance pen in accordance with one embodiment of the present invention.

FIG. 3 is an explosion drawing illustrating an electrical signal transmitting module of a retractable capacitance pen in accordance with one embodiment of the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components. Although specific embodiments have been illustrated and described, it will be appreciated by those skilled in the art that various modifications may be made without departing from the scope of the present invention, which is intended to be limited solely by the appended claims.

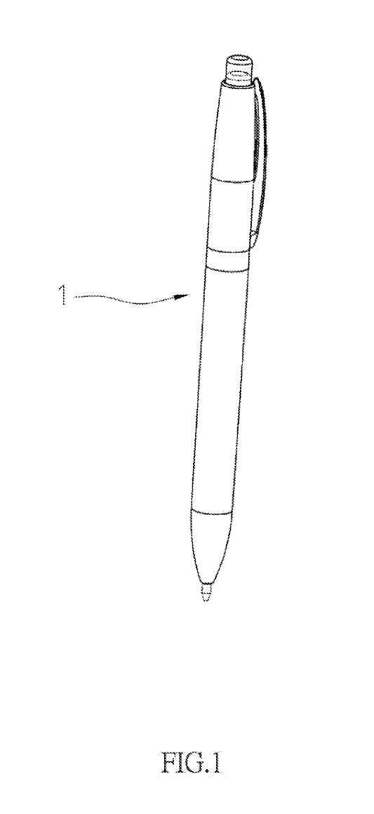

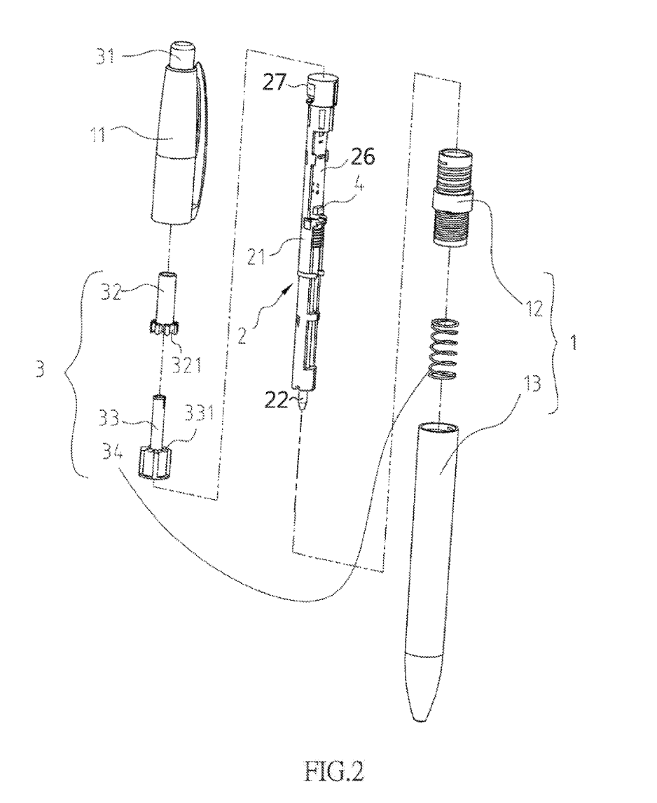

Please refer to FIG. 1 and FIG. 2, they are a stereo drawing and n explosion drawing illustrating a retractable capacitance pen in accordance with one embodiment of the present invention respectively. The retractable capacitance pen of this invention comprises a pen case 1, an electrical signal transmitting module 2, an extension-and-retraction unit 3, and a switching unit 4. The pen case 1 comprises a top barrel 11, a middle barrel 12, and a front barrel 13, and there is a hollow space in the pen case 1, which is formed by the top barrel 11, the middle barrel 12, and the front barrel 12.

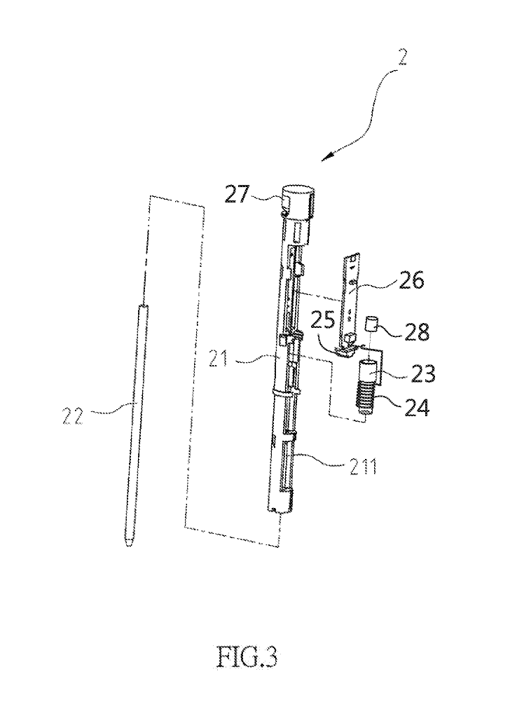

Next, please refer to FIG. 1, FIG. 2, and FIG. 3 simultaneously, FIG. 3 is an explosion drawing illustrating the electrical signal transmitting module 2 of the retractable capacitance pen in accordance with one embodiment of the present invention (illustrated in FIG. 1 and FIG. 2). The electrical signal transmitting module 2 is deposited in the pen case 1. When the electrical signal transmitting module 2 works or operates, the electrical signal transmitting module 2 can emit an electrical signal to a touch panel device (or a touch device). The electrical signal transmitting module 2 comprises a pen frame 21, a core 22, a core holder 23, a spring 24, a sensor holder 25, a circuit board 26, and a power unit 27. The pen frame 21 is a frame for depositing other elements (such as the core 22, the core holder 23, the spring 24, the sensor holder 25, the circuit board 26, and the power unit 27) of the retractable capacitance pen in the retractable capacitance pen. A part of the front end of the pen frame 21 is hollow out. It means that there is a hollow space in the front end of the pen frame 21. The circuit board 26 is deposited on the upper portion of the pen frame 21, and the power unit 27 is deposited on the top of the pen frame 21. The power unit 27 is a battery having smaller size and less weight (such as a mercury battery, etc.). There is a conductive sheet (not showed in FIG. 1-FIG. 3) between the power unit 27 (or the battery) and the circuit board 26 for (electrically) connecting the power unit 27 (or the battery) with the circuit board 26 so as to provide the power for working or operation of the electrical signal transmitting module 2. The core 22, the core holder 23, the spring 24, and the sensor holder 25 are deposited in the hollow space in the front end of the pen frame 21. The tail end (or the back end) of the core 22 is deposited in the core holder 23. The spring 24 is looped around the core holder 23 and one end of the spring 24 is (electrically) connected with the circuit board 26. The core 22, the core holder 23, and the spring 24 are made of an elastic material. Therefore, the electrical signal (or current) generated by the circuit board 26 can transmitted to the core 22 through the spring 24 and the core holder 23. The electrical signal (or current) transmitted to the core 22 can be emitted from the core 22 to the touch devices (such as touch panel, touch screen phone, tablet PC, etc.). The sensor holder 25 is deposited between the core holder 23 and the circuit board 26. The sensor holder 25 holds or contains a sensor (not showed in FIG. 1-FIG. 3) therein for detecting the pressure variation caused by the movement of the core 22 or the core holder 23. When the user uses the retractable capacitance pen to write on a writing surface of the touch device, the nib (the head or front end of the core 51) of the retractable capacitance pen moves backward because it is pressed by the writing surface of the touch device. It means that the core 22 and the core holder 23 moves backward and presses the sensor in the sensor holder 25 at this time. Therefore, a pressure is formed and performed to the sensor in the sensor holder 25 when the core 22 and the core holder 23 moves back, and the sensor in the sensor holder 25 can detect the pressure (or force) performed from the nib (the head or front end of the core 51) of the retractable capacitance pen. There is a rubber 28 deposited between the core holder 23 and the sensor holder 25 for preventing the sensor holder 25 (including the sensor therein) from the violent impact caused by the backward movement of the core holder 23 and from the damage caused by the violent impact.

The extension-and-retraction unit 3 is deposited in the pen case 1 for bringing the electrical signal transmitting module to move vertically so as to control the head or the front end of the core 22 (mean the nib) of the retractable capacitance pen to extend outside (or stretch out) the pen case 1 or to retract into (or move back into) the pen case 1. The extension-and-retraction unit 3 comprises a button 31, a moving connecting rod 32, a fixing connecting rod 33, and a spring 34. The spring 34 is looped around the front end (or the head) of the electrical signal transmitting module 2 for providing a power to retract the front end (or the head) of the electrical signal transmitting module 2 into the pen case 1. The button 31, the moving connecting rod 32, and the fixing connecting rod 33 are deposited in the upper portion of the top barrel 11 of the pen case 1. The button 31 extends out from the top of the top barrel 11. When the user presses the button 31 down, the button 31 is temporarily held or fixed at a depressed location (or in a depressed situation) by integrating the raised tooth 321 of the moving connecting rod 32 with the flanks 331 of the fixing connecting rod 33. When the user presses the button 31 again, the button 31 moves back to the original location. This mechanism is similar to the prior art and thereby it is not mentioned again. The end face of the bottom of the fixing connecting rod 33 contacts the top of the electrical signal transmitting module 2 in the pen case 1. Therefore, when the button 31 is pressed (down), it forces or presses the electrical signal transmitting module 2 to move down along the longitudinal direction of the retractable capacitance pen (or vertical direction). It makes the front end of the core 22 of the electrical signal transmitting module 2 (or the nib of the retractable capacitance pen) to stretch out from the bottom of the pen case 1. When the user presses the button 31 again, the electrical signal transmitting module 2 moves upward along the longitudinal direction of the retractable capacitance pen (or vertical direction) because of the elasticity of the spring 34. Therefore, the front end of the core 22 of the electrical signal transmitting module 2 (or the nib of the retractable capacitance pen) retract into (or move back into) the pen case 1.

The switching unit 4 is deposited in the electrical signal transmitting module 2 deposited in the pen case 1 to be used as a switch of the electrical signal transmitting module 2. The switching unit 4 is a microswitch. There is a trigger member deposited in the middle barrel 12 of the pen case 1. Therefore, the trigger member is not showed in the drawings of this invention. The trigger member is deposited in the way which the switching unit passes through when the electrical signal transmitting module vertically moves in the pen case 1. Therefore, when the electrical signal transmitting module 2 moves down along the longitudinal direction of the retractable capacitance pen (or vertical direction), the trigger member inside the pen case 1 triggers (or activates) the switching unit 4 for turning on the electrical signal transmitting module 2. At this time, the electrical signal transmitting module 2 starts to emit the electrical signal (or current). When the user finishes handwriting input and presses the button 31 again, the front end of the core 22 of the electrical signal transmitting module 2 (or the nib of the retractable capacitance pen) is retracted into (or move back into) the pen case 1 by linkage between the electrical signal transmitting module 2 and the extension-and-retraction unit 3. Therefore, the trigger member inside the pen case 1 triggers (or activates) the switching unit 4 again for turning off the electrical signal transmitting module 2. At this time, the electrical signal transmitting module 2 stops emitting the electrical signal (or current). In the embodiment, the switching unit 4 is a triggered switch, but it is not a limit. Any switch, which can be triggered or activated to maintain the electrical signal transmitting module 2 in the one of switching-on situation and switching-off situation, can be used as the switching unit of the retractable capacitance pen of this invention.

Therefore, when the user writes on the touch device, he presses the button 31 of the extension-and-retraction unit 3 so as to force (or press) the electrical signal transmitting module 2 to move down along the longitudinal direction of the retractable capacitance pen (or vertical direction). It makes the front end of the core 22 of the electrical signal transmitting module 2 (or the nib of the retractable capacitance pen) to stretch out from the bottom of the pen case 1. At the same time, the trigger member inside the pen case 1 triggers (or activates) the switching unit 4 for turning on the electrical signal transmitting module 2. Therefore, the electrical signal transmitting module 2 starts to emit the electrical signal (or current). When the user stops writing on the touch device and presses the button 31 again, the electrical signal transmitting module 2 moves upward along the longitudinal direction of the retractable capacitance pen (or vertical direction) because of the elasticity of the spring 34. Therefore, the front end of the core 22 of the electrical signal transmitting module 2 (or the nib of the retractable capacitance pen) retract into (or move back into) the pen case 1. At the same time, the trigger member inside the pen case 1 triggers (or activates) the switching unit 4 again for turning off the electrical signal transmitting module 2. Therefore, the electrical signal transmitting module 2 stops emitting the electrical signal (or current). Accordingly, the retractable capacitance pen of this invention is not maintained in switch-on situation all the time, and it can employ the battery having smaller size (such as a mercury battery).

According to foregoing embodiments, the retractable capacitance pen of this invention has an electrical signal transmitting module, in which all elements (such as the pen frame, the core, the core holder, the spring, the sensor holder, the circuit board, and the power unit) can synchronously move in vertical direction, an extension-and-retraction unit capable of bringing the electrical signal transmitting module to move in vertical direction, and a switch unit triggered (or activated) to be turned on of turned off during vertical movement of the electrical signal transmitting module. By this construction, the user can press the button of the extension-and-retraction unit to control whether the core stretches out the pen case or the core retracts into the pen case. By this way, the user can control whether the electrical signal transmitting module is turned on or turned off (means electrical signal transmitting module to emit electrical signals or not). Therefore, the user can follow his or her own will to turn on and turn off the retractable capacitance pen. It means that the retractable capacitance pen is turned on only when the user wants to use the retractable capacitance pen. And, the retractable capacitance pen is turned off when the user does not want to use the retractable capacitance pen. Therefore, unlike the conventional capacitance pen, the retractable capacitance pen of this invention needn't emit the electrical signal all the time. The (electrical) power consumption of the retractable capacitance pen can be decreased. Therefore, the battery having smaller size and less weight (such as a mercury batter, etc.) can be employed in the retractable capacitance pen of this invention, and the size and the weight of the (retractable) capacitance pen can be decreased. By this way, the (retractable) capacitance pen can have more variations of designs of modeling and shapes.

What is claimed is:

1. A retractable capacitance pen, comprising:
a pen case;
an electrical signal transmitting module deposited in the pen case for emitting an electrical signal to a touch panel device wherein the electrical signal transmitting module comprises a pen frame, a core, a core holder, a spring, a sensor holder, a circuit board, and a power unit, and the electrical signal transmitting module emits the electrical signal when the electrical signal transmitting module works;
an extension-and-retraction unit deposited in the pen case for bringing the electrical signal transmitting module to move vertically and for controlling a front end of the core to extend outside the pen case or to retract into the pen case; and
a switching unit deposited in the pen case to be used as a switch of the electrical signal transmitting module wherein when the electrical signal transmitting module moves, the switching unit is triggered to control the electrical signal transmitting module to be maintained in the one of switching-on situation and switching-off situation.

2. The retractable capacitance pen of claim 1, wherein the core, the core holder, and the spring are made of an elastic material.

3. The retractable capacitance pen of claim 1, wherein the pen frame is a frame for depositing other elements of the retractable capacitance pen in the retractable capacitance pen, and a part of the front end of the pen frame is hollow out.

4. The retractable capacitance pen of claim 3, wherein the circuit board is deposited on the pen frame for controlling the electrical signal transmitting module to emit the electrical signal.

5. The retractable capacitance pen of claim 3, wherein the power unit is deposited on top end of the pen frame for providing power to the electrical signal transmitting module.

6. The retractable capacitance pen of claim 3, wherein the core, the core holder, and the spring are deposited in a hollow-out space in the front end of the pen frame.

7. The retractable capacitance pen of claim 1, wherein tail end of the core is deposited in the core holder.

8. The retractable capacitance pen of claim 1, wherein the spring is looped around the core holder and one end of the spring is electrically connected with the circuit board.

9. The retractable capacitance pen of claim 1, wherein the sensor holder comprises a sensor therein for detecting the pressure variation caused by the movement of the core or the core holder.

10. The retractable capacitance pen of claim 1, wherein the pen case comprises a top barrel, a middle barrel, and a front barrel, and there is a hollow space in the pen case comprised of the top barrel, the middle barrel, and the front barrel.

11. The retractable capacitance pen of claim 1, wherein there is a trigger member deposited in the middle barrel, and the trigger member deposited in the way, which the switching unit passes through when the electrical signal transmitting module vertically moves in the pen case, for triggering the switching unit when the electrical signal transmitting module vertically moves in the pen case.
